(19) United States
(12) Patent Application Publication
(10) Pub. No.: US 2011/0154669 A1
(43) Pub. Date: Jun. 30, 2011

(54) DOUBLE STRENGTH PRUNERS

(76) Inventors: Hongbin Liu, Hangzhou (CN); Jun Zhang, Hangzhou (CN); Maocai Huang, Hangzhou (CN)

(21) Appl. No.: 12/965,428

(22) Filed: Dec. 10, 2010

(30) Foreign Application Priority Data
Dec. 25, 2009 (CN) 200920318542.8

(51) Int. Cl. A01G 3/02

(52) U.S. Cl. 30/260; 30/261

(57) ABSTRACT

Double strength pruners have two crossed pivoting blades, a main blade and an auxiliary blade, upper and lower handles correspondingly matching the two blades, a blade driving gear on the auxiliary blade, and upper and lower gears at the end of the upper and lower handles, respectively, the lower gear matching the blade driving gear. When swinging the upper handle and/or the lower handle, a first leverage effect is created from a first fulcrum, which is the contact point between the upper and lower gears, while a second leverage effect is created from a second fulcrum, which is the contact point between the lower gear and the blade driving gear. Such double levers and double strength effects can significantly reduce the force applied upon the handles, reducing the required labor. The upper gear, lower gear, upper handle and lower handle are detachable structures, easy for maintenance and replacement.

This application claims the benefit of Chinese Application No. 200920318542.8, filed Dec. 25, 2009, which is hereby incorporated by reference in its entirety.

### BACKGROUND

Conventional pruners have two blades connected by a pin axis with handles fastened to the blades. With a fixed handle length and settled pin axis position, force applied to the blades is invariable. Because ornamental tree branches are relative large, cutting requires great strength and results in extensive labor. Bigger branches require even more labor. Failure to cut branches often occurs.

Needs exist for improved pruners requiring less force for operation.

### SUMMARY

It is to be understood that both the following summary and the detailed description are exemplary and explanatory and are intended to provide further explanation of the invention as claimed. Neither the summary nor the description that follows in intended to define or limit the scope of the invention to the particular features mentioned in the summary or in the description. Rather, the scope of the invention is defined by the appended claims.

In certain embodiments, the disclosed embodiments may include one or more of the features described herein.

A new double strength pruner has a main blade and an auxiliary blade connected by a pivot, an upper handle and lower handle correspondingly matching with the main blade and the auxiliary blade, a blade driving gear positioned on the auxiliary blade, and an upper gear and a lower gear, respectively positioned at the end of the upper handle and the lower handle. The lower gear matches with the blade driving gear.

In one embodiment, the upper gear, lower gear, upper handle and lower handle are detachable structures, the upper gear and lower gear can be positioned correspondingly in the inner cavity of the upper handle and lower handle, the rear ends of the upper gear and lower gear extend correspondingly to form into an upper link rod and a lower link rod, and the upper link rod and lower link rod are connected to the upper handle and lower handle. A first link is positioned between the upper link rod and the lower link rod and a second link is positioned between the main blade and the lower link rod. A latch hook is positioned on the upper link rod and matching latch components are positioned against the latch hook on the lower handle. The latch components include a movable latch rod positioned on the lower handle and a hand-pushed block matching with the latch rod, where the hand-pushed block matches with the outer wall of the lower handle.

In some embodiments, a resetting spring is positioned between the upper handle and lower handle. In one embodiment a head is positioned at the connection of the main blade, the auxiliary blade, and the upper handle and lower handle. In one embodiment the auxiliary blade and the blade driving gear are one piece.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a diagram showing the exploded structure of a double strength pruner.

FIG. 2 is a diagram showing two blades of a double strength pruner in an open position.

FIG. 3 is a diagram showing the inner workings of the double strength pruner shown in FIG. 2.

FIG. 4 is a diagram showing two blades of a double strength pruner in a closed position.

FIG. 5 is a diagram showing the inner workings of the double strength pruner shown in FIG. 4.

### DETAILED DESCRIPTION

Double strength pruners will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

New double strength pruners contain three sets of gear driving pieces and employ double leverage effects. With double strength from two levers, these pruners reduce the power originally required to cut high branches, require less labor, and resolve the problems of current technology.

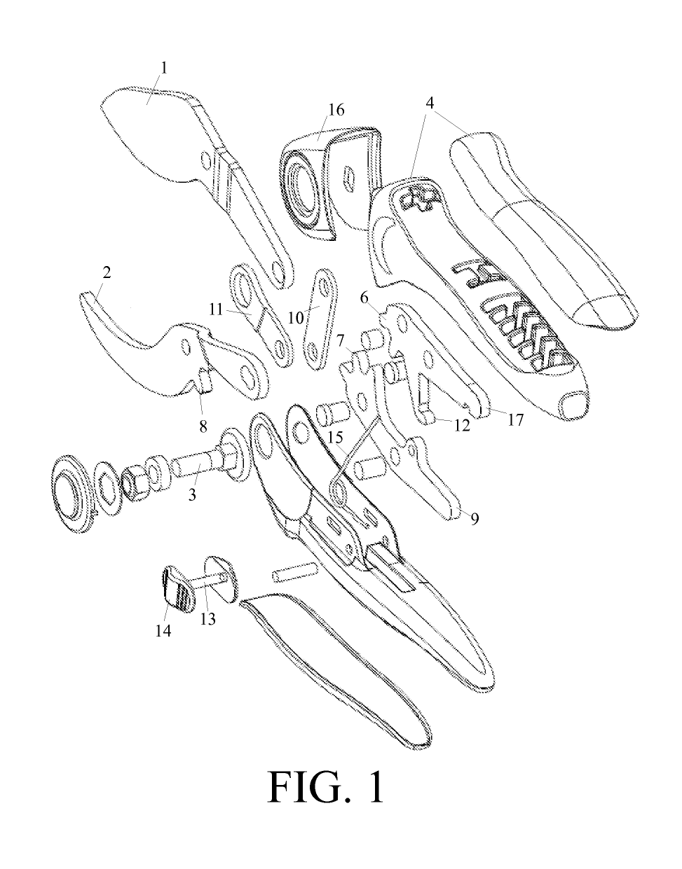

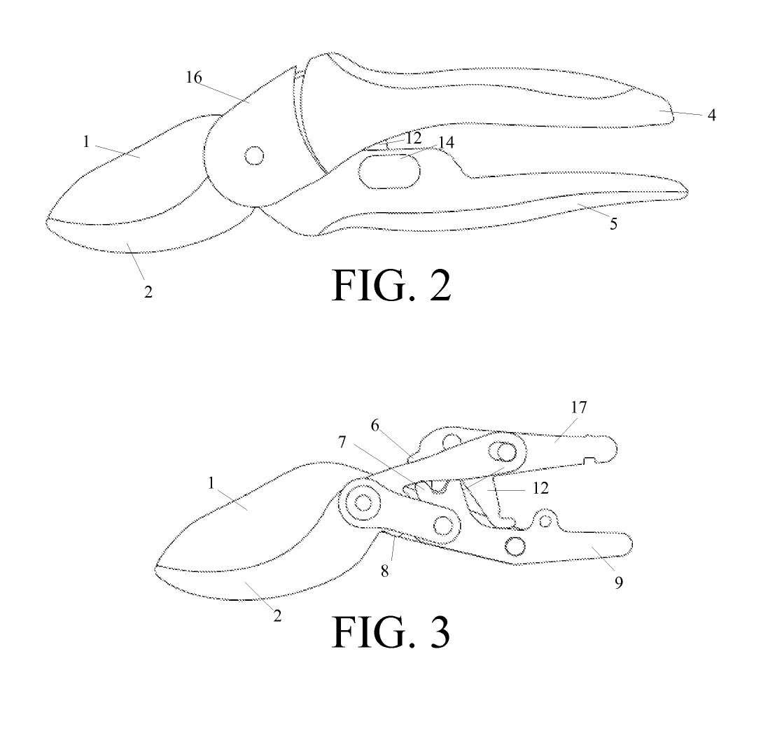

In some embodiments the double strength pruners include a main blade and auxiliary blade connected to a pivot, and upper and lower handles correspondingly matching with the main and auxiliary blades. The features include the blade driving gear positioned on the auxiliary blade, the upper gear and lower gears respectively positioned at the end of the upper handle and the lower handle, and the lower gear matching with the blade driving gear. The upper and lower handle and the upper and lower gear refer to relative positions. The main and auxiliary blades are also relative. They are used for the purpose of convenience to differentiate the two blades, the upper and lower handles, and the upper and lower gears (See FIGS. 1 and 2 for details). This also applies to the following reference to upper and lower, main and auxiliary.

In use, when swinging the upper handle and/or lower handle, the upper gear and lower gear correspondingly rotate. A first leverage effect is created from the first fulcrum that is the contact point between the upper gear and lower gear, while a second leverage effect is created from the second fulcrum that is the contact point between the lower gear and the blade driving gear. Such double levers and double strength effect can significantly reduce the force applied upon the upper and lower handles, therefore reducing the required labor. With this design, it is relatively easy to cut bigger branches.

To perfect and supplement the above design, in some embodiments these pruners include further innovations. The upper gear and lower gear and the upper handle and lower handle are detachable structures. The upper gear and lower gear are correspondingly positioned into the inner cavity of the upper handle and lower handle. The rear end of the upper gear and lower gear extend correspondingly to form into an upper link rod and a lower link rod. And the upper link rod and lower link rod are connected to the upper handle and lower handle. Due to wear and tear or rupture, the upper and lower gear can be replaced without replacing handles, which reduces maintenance cost.

Link A is positioned between the upper link rod and the lower link rod, and Link B is positioned between the main blade and the lower link rod. Link A moves the upper and lower link rods to swing up and down at the contact point between the upper gear and lower gear. Link B enables the lower gear and the blade driving gear to always engage with each other during the rotation. There is a latch hook on the upper link rod, and there are matching latch components with the latch hook on the lower handle. When pruners are not in use, the latch hook can hook with latch components to lock the upper and lower handle, which can prevent accident.

The latch components consist of a movable latch rod on the lower handle and a hand-pushed block that matches with the latch rod. The hand-pushed block is matched with the outer wall of the lower handle. Pushing the hand-pushed block on the outer wall of the handle can move the latch rod. The movement of the latch rod in return enables the latch rod to go into the latch hook or disconnect with the latch hook, which locks and unlocks the pruners.

A resetting spring is positioned between the upper handle and lower handle. There is no need to manually separate the upper and lower handle. The resetting spring functions to separate them. This design helps to increase productivity as well as reduce labor.

A head is positioned at the connection of the main blade, auxiliary blade, upper handle and lower handle. The pruner's head can cover the joints of the pruner's many key components, which can prevent miscellaneous articles falling into these joints. This design helps to increase the pruners' reliability.

In some embodiments the auxiliary blade and the blade driving gear are a single piece.

The benefits include: 1. when swinging the upper handle and/or the lower handle, a first leverage effect is created from the first fulcrum that is the contact point between the upper gear and the lower gear, while a second leverage effect is created from the second fulcrum that is the contact point between the lower gear and the blade driving gear. Such double levers and double strength effects significantly reduce the force applied upon the upper and lower handles, therefore reducing the required labor. 2. The upper gear, lower gear, upper handle and lower handle are detachable structures, easy for maintenance and replacement.

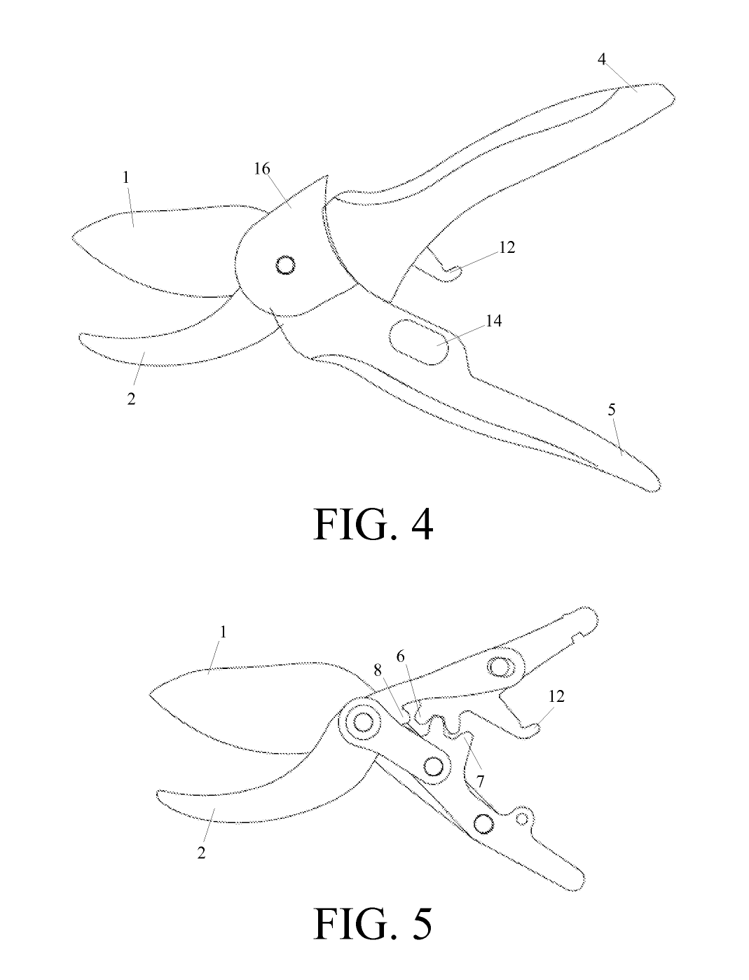

As illustrated by FIGS. 1-5, in some embodiments double strength pruners contain a main blade (1) and auxiliary blade (2) connected by a pivot (3), an upper handle (4) that matches with the main blade (1) and a lower handle (5) that matches with the auxiliary blade (2), a blade driving gear (8) on the auxiliary blade (2), a upper gear (6) at the end of the upper handle (4) and a lower gear (7) at the end of the lower handle (5), where the lower gear (7) matches with the blade driving gear (8). A head (16) is positioned at the connection of the main blade (1), auxiliary blade (2), upper handle (4) and lower handle (5). The auxiliary blade (2) and the blade driving gear (8) are one piece. A resetting spring (15) is positioned between the upper handle (4) and lower handle (5). One end of the resetting spring (15) goes into and leans against the lower handle (5). The other end leans against the axis that connects the upper link rod (17) and the upper handle (4).

The upper gear (6), lower gear (7), upper handle (4) and lower handle (5) are detachable structures. Upper and lower gears can be correspondingly positioned into the inner cavity of the upper handle (4) and lower handle (5). The rear end of upper gear (6) and lower gear (7) extend correspondingly to form into an upper link rod (17) and a lower link rod (9). The upper link rod (17) and lower link rod (9) are connected to the upper handle (4) and lower handle (5).

Link A (10) is positioned between the upper link rod (17) and the lower link rod (9), and Link B (11) is positioned between the main blade (1) and the lower link rod (9).

There is a latch hook (12) on the upper link rod (17), and there are latch components that match with the latch hook (12) on the lower handle (5). The latch components consist of a movable latch rod (13) on the lower handle (5) and the hand-pushed block (14) that matches with the latch rod (13). The hand-pushed block (14) is matched with the outer wall of the lower handle (5).

When swinging the upper handle and/or the lower handle, the upper gear and the lower gear start to rotate. This creates a first leverage effect from the first fulcrum that is the contact point between the upper gear and the lower gear. The rotation of the upper gear and lower gear further rotates the blade driving gear. This creates a second leverage effect from the second fulcrum that is the contact point between the lower gear and the blade driving gear. Such double levers and double strength effects can significantly reduce the force applied upon the upper and lower handles, therefore reducing the required labor. This design can relatively easily cut bigger branches.

The invention is not limited to the particular embodiments illustrated in the drawings and described above in detail. Those skilled in the art will recognize that other arrangements could be devised. The invention encompasses every possible combination of the various features of each embodiment disclosed. While the invention has been described with reference to specific illustrative embodiments, modifications and variations of the invention may be constructed without departing from the scope of the invention.

I claim:

1. A double strength pruner, comprising:
a main blade and auxiliary blade connected by a pivot;
an upper handle and lower handle correspondingly matching with the main blade and the auxiliary blade;
a blade driving gear positioned on the auxiliary blade; and
an upper gear and a lower gear, respectively positioned at the end of the upper handle and the lower handle;
wherein the lower gear matches with the blade driving gear.

2. A double strength pruner according to claim 1, wherein the upper gear, lower gear, upper handle and lower handle are detachable structures, the upper gear and lower gear can be positioned correspondingly in the inner cavity of the upper handle and lower handle, the rear ends of the upper gear and lower gear extend correspondingly to form into an upper link rod and a lower link rod, and the upper link rod and lower link rod are connected to the upper handle and lower handle.

3. A double strength pruner according to claim 2, further comprising a first link positioned between the upper link rod and the lower link rod and a second link positioned between the main blade and the lower link rod.

4. A double strength pruner according to claim 2, further comprising a latch hook positioned on the upper link rod and matching latch components positioned against the latch hook on the lower handle.

5. A double strength pruner according to claim 4, wherein the latch components comprise a movable latch rod positioned on the lower handle and a hand-pushed block matching with the latch rod, wherein the hand-pushed block matches with the outer wall of the lower handle.

6. A double strength pruner according to claim 1, further comprising a resetting spring positioned between the upper handle and lower handle.

7. A double strength pruner according to claim 4, further comprising a resetting spring positioned between the upper handle and lower handle.

8. A double strength pruner according to claim 5, further comprising a resetting spring positioned between the upper handle and lower handle.

9. A double strength pruner according to claim 8, further comprising a head positioned at the connection of the main blade, the auxiliary blade, and the upper handle and lower handle.

10. A double strength pruner according to claim 8, wherein the auxiliary blade and the blade driving gear are one piece.
